(19) United States
(12) Patent Application Publication
(10) Pub. No.: US 2008/0217897 A1
(43) Pub. Date: Sep. 11, 2008

(54) Roll-over protective system for motor vehicles with a collapsible roll bar

(75) Inventor: Holger Latussek, Bergneustadt (DE)

Correspondence Address: HUDAK, SHUNK & FARINE, CO., L.P.A., 2020 FRONT STREET, SUITE 307, CUYAHOGA FALLS, OH, 44221, US

(73) Assignee: AUTOMOTIVE GROUP ISE INNOMOTIVE SYSTEMS EUROPE GMBH, BERGNEUSTADT (DE)

(21) Appl. No.: 12/072,727

(22) Filed: Feb. 28, 2008

(30) Foreign Application Priority Data
Mar. 5, 2007 (DE) 10 2007 011 106.3

(51) Int. Cl. B60R 21/13

(52) U.S. Cl. 280/756

(57) ABSTRACT

A roll-over protective system for motor vehicles, with roll-over bars arranged at the vehicle's seats, each one being accommodated in a support fixed to the vehicle, and in the normal condition being held by a holding device in a lower, descended position of rest, and able to be brought into a raised, supporting position by releasing of the holding device under sensor control, wherein each roll-over bar has two legs, each of them pivoted at a spacing in the transverse axis of the vehicle with one end in bearings in the support fixed to the vehicle and able to fold down toward each other with their free end, and being interlocked in the raised condition. In order to hinder a digging in of the roll-over bar in soft ground, at least one of the two legs of the bar has a flattening in the region of the free end. In order to enable a locking of the legs of the bar in intermediate positions as well, the mutual interlocking of the two raised legs of the bar is such that a locking can be activated not only in the end position, but also in intermediate positions.

### FIELD OF THE INVENTION

The invention concerns a roll-over protective system for motor vehicles, with roll-over bars arranged at the vehicle's seats, each one being accommodated in a support fixed to the vehicle, and in the normal condition being held by a holding device in a lower, descended position of rest, and able to be brought into a raised, supporting position by releasing of the holding device under sensor control, wherein each roll-over bar has two legs, each of them pivoted at a spacing in the transverse axis of the vehicle with one end in bearings in the support fixed to the vehicle and able to fold down toward each other with their free end, and being interlocked in the raised condition.

### BACKGROUND OF THE INVENTION

Such roll-over protective systems serve to protect the passengers of motor vehicles without a protective roof, typically convertibles or sports cars, by overarching a survival space for the passengers in the event of a rollover. They are known, for example, from DE 10 2005 059 910 B3.

With such a system and relatively little expense it is possible to create a seat-connected roll-over protective system with a collapsible bar, which stays collapsed in the support position and in event of an impending roll-over travels from the collapsed support position into a deployed locked position, in which case the folded-up legs of the bar rise up and are interlocked in the raised position.

This makes it possible, even for vehicles having but slight space available, to integrate an effective roll-over protective system with a folding bar, particularly in vehicles where the space in the region of the seat back beneath the folding bar is needed for other purposes. This applies, for example, where space needs to be available for stowage of cargo or a folding roof.

Likewise, this creates the possibility of integrating additional strength-boosting components.

The proposal per DE 10 2005 059 910 B3, moreover, leads to an economical roll-over protective system having few structural parts, which decisively handles the cost pressure prevailing in the automotive industry, especially the auto parts sector.

The folding process can vary according to the shape of the bar legs. It they have a shell construction, for example, the folded legs lie one on top of the other; if the legs are flat, they will lie alongside each other; and if the legs are tubular, they can also move concentrically to each other.

In the design according to the cited document, the folding bar is configured so that, in the raised condition, the two legs of the bar form a triangle with the base frame. Thanks to this triangular configuration and the rotary mounting of the legs, they act as compression members and accordingly can transmit very large compressive forces to the vehicle's structure.

On the other hand, however, due to the pronounced apex of the raised triangle, the triangle geometry results in poor behavior of the roll-over bar in event of a roll-over on soft ground, i.e., the roll-over bar has a poor, so-called dig-in behavior. What is more, there is some risk of injury to the passengers in this regard.

Moreover, the familiar folding bar is configured such in regard to the retraction blockage, i.e., the corresponding interlocking, that it is only locked in the fully raised condition of the folding bar, i.e., in its end position. There is no locking in intermediate positions.

### SUMMARY OF THE INVENTION

The basic problem of the invention is to improve a folding bar of the above mentioned kind so that it offers sufficient protection against digging into soft ground.

The solution of this problem, according to the invention, in the roll-over protective system for motor vehicles of the kind mentioned above, with roll-over bars arranged at the vehicle's seats, each one being accommodated in a support fixed to the vehicle, and in the normal condition being held by a holding device in a lower, descended position of rest, and able to be brought into a raised, supporting position by releasing of the holding device under sensor control, wherein each roll-over bar has two legs, each of them pivoted at a spacing in the transverse axis of the vehicle with one end in bearings in the support fixed to the vehicle and able to fold down toward each other with their free end, and being interlocked in the raised condition, is that at least one of the two legs of the bar has a flattening in the region of the free end.

Moreover, in order to achieve an interlocked supporting (retraction blockage) in intermediate positions, i.e., also when the legs of the bar are not placed in their end position, according to the invention the mutual interlocking of the two raised legs of the bar is such that a locking can be activated not only in the end position, but also in intermediate positions.

Thanks to the invented configuration of the legs of the bar, first the apex of the triangularly raised folding bar is distinctly flattened, so that a digging of the folding bar into soft ground is significantly hindered. Secondly, a retraction block is created which also enables a locked support for the folding bar when the legs are not raised into the end position.

Further configurations and modifications of the invention are described in the subclaims and also result from the description of the figures.

### BRIEF DESCRIPTION OF THE DRAWINGS

The invention shall be explained more closely by means of two advantageous sample embodiments represented in the patent drawings in different views and conditions.

These show:

FIG. 1, in a frontal view, two folding bars configured according to the invention in a first embodiment, arranged on a transverse member alongside each other in the transverse direction of the vehicle, with curved legs covered at the top end, one folding bar being shown in the raised state and the other folding bar in the stowed-away condition of rest, with a spring drive for the raising of the inward lying leg of the bar and a toothed strip in the outward lying leg of the bar for interlocking with a complementary locking element arranged at the top end on the inner leg for a locking of the two legs even in intermediate positions,

FIG. 2, a roll-over bar system per FIG. 1, without a cover at the top end and with a cutaway outward lying leg to illustrate the interlocking of the two legs of the bar,

FIG. 3, the roll-over bar system per FIG. 2, without transverse member, to illustrate the inward lying leg of the bar,

FIG. 4, the roll-over bar system per FIG. 2 without transverse member, in a rear view to illustrate the holding device for holding the folding bar down in the stowed-away condition of rest,

FIG. 5, in a frontal view, two folding bars configured according to the invention in a second embodiment, arranged on a transverse member alongside each other in the direction of travel, one folding bar being shown in the raised state and the other folding bar in the stowed-away condition of rest, with two legs flattened in an arc in the upper region, and interlocking elements arranged in this region for the retraction blockage,

FIG. 6, the fully raised and locked folding bar per FIG. 5 in a cross sectional diagram,

FIG. 7, in a representation corresponding to FIG. 6, the folding bar raised in a first intermediate position and locked, showing the complete raising (end position) by hatch marks, and

FIG. 8, in a cross sectional diagram, the fully raised folding bar per FIG. 6, superimposed with the depiction of the folding bar in the stowed-away condition of rest.

### DETAILED DESCRIPTION OF THE INVENTION

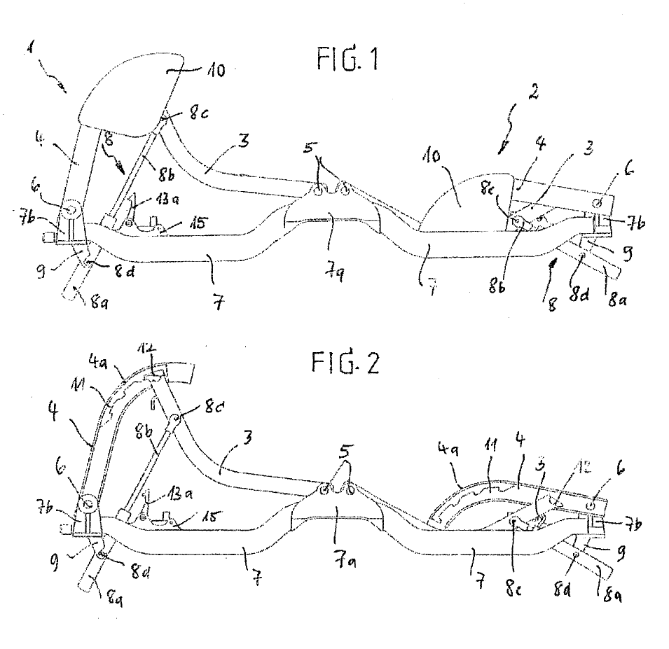

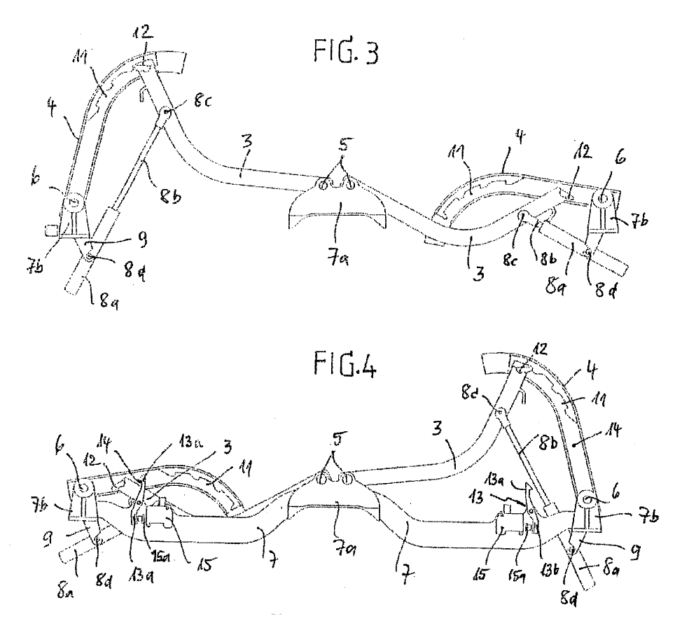

FIGS. 1 to 4 show a first embodiment of the invention. They show two folding bars 1, 2 arranged at the seats, folding bar 1 being shown in the fully raised and supporting position and the other folding bar 2 in the lower stowed-away position of rest.

Each folding bar has a driven inner leg 3 and a nondriven outer leg 4, one end of which can turn in bearings 5 and 6 in a pillow block section 7a and 7b of a vehicle-fixed transverse member 7 of the rear wall of the backseat space, and the other ends are in connection with each other and can move toward each other.

In the sample depicted, the roll-over protective system is configured according to the design principle with a rear wall structural unit, as is described, e.g., in DE 103 44 446 B3. This principle has a frame structure arranged between backseats and trunk, whose major component is a transverse profile beam (here, 7) fixed to the car body and stretching across the inner width of the vehicle, which receives the roll bar. Its profile can be C-shaped, for example. However, other ways of fixing the folding bar to the body are also conceivable. As the drive for raising the inner leg 3, a spring drive 8 is provided in the manner of a spring lifting element, which in familiar fashion consists of a drive cylinder 8a, containing a compression spring, and a piston with piston rod 8b able to move in the cylinder, being linked to the driven inner leg 3 at the pivot point 8c. The drive cylinder 8a has a wrist pin 8d, which engages with a bearing hook 9 secured in the bearing 6, thereby holding the lower end of the drive in hinged manner, fixed to the car body.

The construction and operation of such a spring drive are sufficiently known and therefore do not need to be further described here.

Other spring drives can also be provided, e.g., spring drives with helical, torsion or spiral springs.

A pyrotechnical drive can also be used in theory.

Furthermore, both legs 3, 4 of the bar can be driven in theory.

In order to improve the digging-in behavior in soft ground, the nondriven outer leg 4 in the first embodiment is rounded or flattened in the upper region 4a. This upper region 4a is further provided with a sheet-like covering 10 of foam plastic, or metal (plate), as shown in FIG. 1.

Thanks to the rounding or flattening of the outer leg 4, there is first of all a greater space requirement in the vertical direction when the folding bar is in the stowed-away condition.

In order to receive the driven inner leg 3 movably in the outer leg 4 with constrained guidance as it is raised, the latter is also curved in the first embodiment, so that the two legs 3, 4 of the bar can be compactly folded together like mussels, as the stowed-away folding bar 2 shows more closely.

So that the raised legs 3, 4 of the bar cannot be forced inward during a rollover, they must be locked in the raised position (retraction blockage). The corresponding locking device in the case of the invention is designed for safety reasons so that a locking is also possible in intermediate positions beneath the end position. For this, in the case of the first embodiment, there is provided an appropriately curved toothed strip 11 inside the outer leg 4 in its upper, curved region 4 and a complementary tip 12 on the other leg 3 at the top, with spring resilience preferably in the direction of the raising motion.

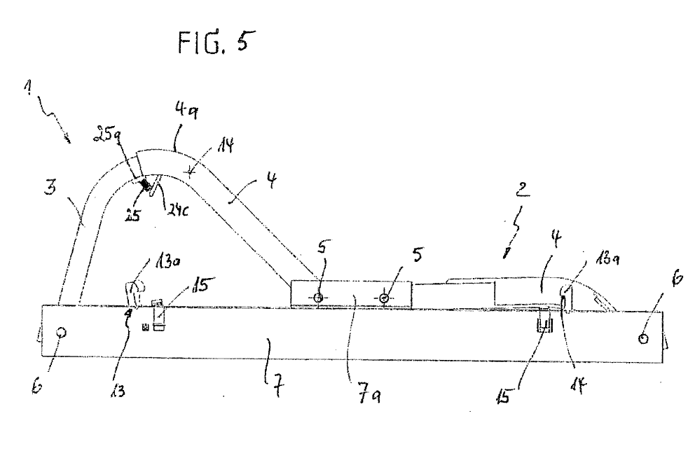

In the folded, i.e., stowed-away condition of rest of the bar (here, bar 2), it is held in this position by a releasable holding device. A number of designs are conceivable for this holding device, such as are known in particular from the relevant prior art. In the sample embodiment shown, as FIG. 4 in particular shows, it consists of a two-arm detent latch 13, hinged (with prestressing) to the transverse member fixed to the car body, with a hook-shaped lever arm 13a, which is in active connection to a holding element, formed by a holding pin 14 fastened to the nondriven leg 4 of the bar.

The other lever arm 13b of the detent latch 13 is in active connection with a release pin 15a of an actuator 15, arranged firmly on the car body, which can be an electromagnetic or pyrotechnical actuator.

If the actuator 15 is activated under sensor control during an impending rollover, it pushes out the release pin 15a, which in turn swivels the detent latch 13 and thereby releases the holding pin 14—and thus also the outer leg of the bar—so that the spring drive 8 raises the inner leg 3, which then raises as well the nondriven outer leg 4 via the forced coupling of the two legs, until both of them reach the end position (here, bar 1) and lock the tip 12 at the top end in this position by means of the toothed strip 11.

If the end position is not reached, the toothed strip 11 makes sure that a locking will also occur in intermediate positions.

Of course, other basically familiar interlocking mechanisms, such as a bolt locking, can also be used.

FIGS. 5 to 8 show a second embodiment of the invented folding bar. This likewise has an outer leg 4 with a flattened or curved upper region 4a and an inner leg 3. The one ends of these legs are, as in the first embodiment, linked at the bearing pivot points 5 and 6 in corresponding bearing sections 7a and 7b of the transverse member 7 fixed to the car body.

The legs 3, 4 are shaped and arranged such at the top end that the raising motion occurs by mutual rolling against each other, i.e., the inner and outer legs are not forcibly coupled by a sliding block.

To hold down the stowed-away bar, there are provided a two-arm detent latch 13 and an actuator 15, both of them arranged on the transverse member 7, while the one (hook-shaped) arm 13a of the detent latch in the stowed-away state of the folding bar 2 (FIG. 5, right side) is in active engagement with a holding pin 14, which is arranged on the outer leg 4, and the other arm can be brought into active engagement with the actuator, which is activated under sensor control.

The interlocking of the raised legs 3, 4 occurs by a toothed segment inside the outer leg 4, which can be formed by a curved toothed strip 11 or by corresponding window cutouts in the arched region, in conjunction with a two-arm interlocking rotary pawl 24, which is linked to the tip of the inner leg 3 at the pivot point 24a. The rotary pawl 24 has a locking arm 24b for active engagement with the teeth of the toothed strip 11 and an activation arm 24c, against which a helical retaining spring 25 bears by one end, while it's other end lies against a supporting shoulder 25a in the inner leg 3.

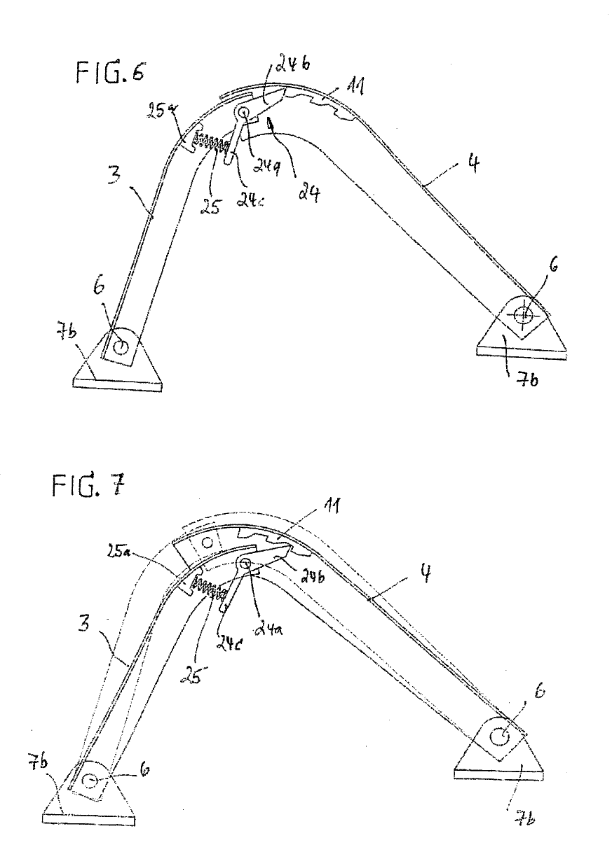

For better clarity, the drive for the raising of the legs 3, 4 is not depicted. Preferably, a spring drive will be used, but a pyrotechnical drive is also conceivable. Preferably, as in the other embodiment, the inner leg 3 is actively raised by the drive. Depending on the spring adjustment of the spring drive, the “passive” outer leg 4 could likewise be catapulted against a stop (not shown) in the end position (FIG. 6). A correspondingly stable bearing of the legs of the bar will ensure that the tips of the legs are securely interlocked with each other.

It would also be conceivable for both legs of the bar to be actively driven; in this case, at least the enclosing outer leg 4 would reach the end position per FIG. 6 and provide locking there.

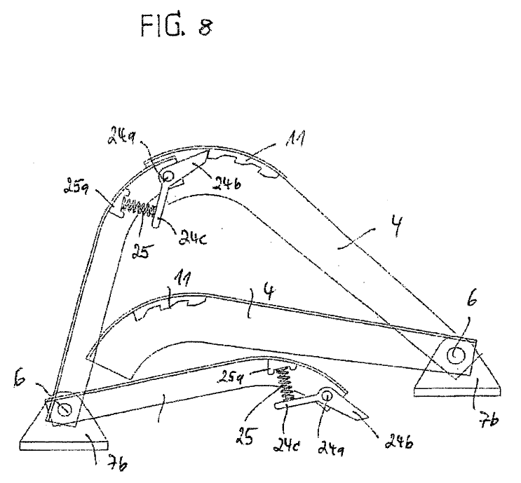

On the other hand, the kinematics of the raising process can also be designed in terms of the geometry of the rolling surface and the spring adjustment of the spring drive so that a second, lower protective position corresponding to FIG. 7 is produced, e.g., when the roof of the convertible is closed, if the two legs of the bar do not reach the full end position. In the case of the folding bar of the system mentioned in the beginning, this will remain in an unlocked position if either one of the two legs is blocked.

The flattening in the upper region of the outer leg 4—and possibly the corresponding region on the inner leg 3—can be curved, arched, or rounded.

### LIST OF REFERENCE NUMBERS

1 raised folding bar
2 lowered folding bar
3 inner leg of bar
4 outer leg of bar
4a flattened upper region
5 bearing (of the inner leg)
6 bearing (of the outer leg)
7 transverse member fixed to car body
7a, 7b segments resembling pillow blocks
8 spring drive
8a drive cylinder
8b piston rod
8c pivot point
8d wrist pin
9 rigid bearing hook
10 cover
11 curved toothed strip
12 complementary tip
13 two-arm detent latch
13a hook-shaped lever arm
13b other lever arm
14 holding pin
15 actuator with release pin
15a release pin
24 interlocking rotary pawl
24a pivot point
24b locking arm
24c activating arm
25 helical retaining spring
25a support shoulder

What is claimed is:

1. A roll-over protective system for motor vehicles, comprising: roll-over bars adapted to be arranged at the vehicle's seats, each roll-over bar being accommodated in a support adapted to be fixed to the vehicle, and in a normal condition being held by a holding device in a lower, descended position of rest, and able to be brought into a raised, supporting position by releasing of a holding device under sensor control, wherein each roll-over bar has two legs, each leg pivoted at a spacing in a transverse axis of the vehicle with one end in bearings in the support fixed to the vehicle and able to fold down toward each other with a free end, and being interlocked in the raised condition, and wherein at least one of the two legs of the bar has a flattening in the region of the free end.

2. A roll-over protective system for motor vehicles, comprising: roll-over bars adapted to be arranged at the vehicle's seats, each roll-over bar being accommodated in a support adapted to be fixed to the vehicle, and in a normal condition being held by a holding device in a lower, descended position of rest, and able to be brought into a raised, supporting position by releasing of a holding device under sensor control, wherein each roll-over bar has two legs, each leg pivoted at a spacing in a transverse axis of the vehicle with one end in bearings in the support fixed to the vehicle and able to fold down toward each other with a free end, and being interlocked in the raised condition, and wherein that the mutual interlocking of the two raised legs of the bar is such that a locking can be activated not only in the end position, but also in intermediate positions.

3. The roll-over protective system per claim 1, with two bar legs, one of which, an outer bar leg, encloses the other bar leg, an inner bar leg, in the collapsed condition, wherein only the outer bar leg has an upper, flattened region.

4. The roll-over protective system per claim 1, with two bar legs, one of which, an outer bar leg, encloses the other bar leg, an inner bar leg, in the collapsed condition, wherein both the outer bar leg and the inner bar leg have an upper, flattened region.

5. The roll-over protective system per claim 1, wherein the flattening is in the shape of an arc.

6. The roll-over protective system per claim 1, wherein the flattening is configured as a rounding.

7. The roll-over protective system per claim 1, wherein the flattening consists of variously curved segments.

8. The roll-over protective system per claim 1, wherein the free ends of the two legs of the bar are coupled together by constraint.

9. The roll-over protective system per claim 8, wherein the free end of one bar leg is configured as a slide block and the interior of the other bar leg as a slotted link.

10. The roll-over protective system per claim 1, wherein a spring drive in the style of a spring lifting element is provided as the drive.

11. The roll-over protective system per claim 1, wherein a helical compression spring is provided as the drive.

12. The roll-over protective system per claim 1, wherein a pyrotechnical drive is provided as the drive.

13. The roll-over protective system per claim 2, wherein a toothed segment with at least two teeth formed at a spacing in conjunction with a complementary locking element for an active engagement with the toothed segment is provided for the interlocking of the two legs of the bar.

14. The roll-over protective system per claim 1, wherein the toothed segment is arranged inside the outer leg of the bar and the complementary locking element at a tip of the inner leg of the bar.

15. The roll-over protective system per claim 2, with two bar legs, one of which, an outer bar leg, encloses the other bar leg, an inner bar leg, in the collapsed condition, wherein only the outer bar leg has an upper, flattened region.

16. The roll-over protective system per claim 2, with two bar legs, one of which, an outer bar leg, encloses the other bar leg, an inner bar leg, in the collapsed condition, wherein both the outer bar leg and the inner bar leg have an upper, flattened region.

17. The roll-over protection system per claim 2, wherein the flattening is in the shape of an arc, configured as a rounding, or consists of variously curved segments.

18. The roll-over protective system per claim 2, wherein the free ends of the two legs of the bar are coupled together by constraint.

19. The roll-over protective system per claim 2, wherein a spring drive in the style of a spring lifting element, a helical compression spring, or a pyrotechnical drive is provided as the drive.

20. The roll-over protective system per claim 2, wherein the toothed segment is arranged inside the outer leg of the bar and the complementary locking element at a tip of the inner leg of the bar.
